(19) United States
(12) Patent Application Publication
(10) Pub. No.: US 2008/0234987 A1
(43) Pub. Date: Sep. 25, 2008

(54) Amalgamation of data models across multiple applications

(75) Inventor: Michael B. Haley, San Rafael, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc.

(21) Appl. No.: 11/710,071

(22) Filed: Feb. 23, 2007

(51) Int. Cl. G06F 15/177; G06F 17/50

(52) U.S. Cl. 703/1

(57) ABSTRACT

A method, apparatus, and article of manufacture provide the ability to synchronize project data models across multiple computer applications. A first computer design application in a first client computer obtains files that provide a first application project definition specific to the first computer design application. A first application specific conversion application converts, on the first client computer, the first application project definition into a unified project definition that is utilized by a server application. The unified project definition is transmitted to the server application that stores the definition and synchronizes it with additional computer design applications.

### CROSS-REFERENCE TO RELATED APPLICATIONS

This application is related to the following commonly-assigned patent, which patent is incorporated by reference herein:

U.S. Pat. No. 7,065,476, entitled “ADAPTABLE MULTI-REPRESENTATION BUILDING SYSTEMS PART”, by Paul Fred DesSureault, Gregory Vazzana, Soren Abildgaard, and Craig Storms, Attorney Docket No. 30566.202-US-01, filed on Apr. 22, 2002 and issued on Jun. 20, 2006.

### BACKGROUND OF THE INVENTION

1. Field of the Invention

The present invention relates generally to computer aided design data models, and in particular, to a method, apparatus, and article of manufacture for amalgamating data models across multiple applications.

2. Description of the Related Art

The design, analysis and construction of sites, facilities and the mechanical devices they employ typically requires the use of multiple separate applications. The applications may be multi-directionally dependent on each other. In addition, the applications may desire to share data. However, in the prior art, none of the different applications use the same data model or project definition. Instead, each data model/project definition is customized for its particular application. Accordingly, what is needed is a mechanism for the multiple applications to collaborate with each other and exchange information in a seamless manner. Such problems may be better understood with a description of the prior art development and use of projects and data sharing.

As described above, the design, analysis and construction of sites, facilities and the mechanical devices they employ typically requires the use of multiple applications. These applications often map to the professionals involved with particular phases of the project. For example, the design of a school requires an architectural design performed by an architect, site design and analysis by a civil engineer, structural analysis by a structural engineer, HVAC (heating, ventilation, and air conditioning) and piping design and layout, etc.

The individual design and analysis tasks performed by these professionals are usually accomplished in separate programs. For example, using applications available from the assignee of the present invention, site design can be performed in Civil 3D™, architectural design in Architectural Desktop™, structural drafting in AutoCAD™, etc. However, there are multi-directional dependencies between the different disciplines. A final building plan cannot be developed until a site plan has been approved. A site plan can't be developed until a preliminary building footprint has been designed. Thus, the successful completion of a design requires coordination between different disciplines.

However, in the prior art, none of the different design/analysis programs employed use the same over-arching data model or project definition. Each data model/project definition is customized for its particular application. As a result of the dependencies between the design tasks, there is clearly a need to share data in a robust way. For example, an architect would like to have access to site surface profiles.

Moreover, there are a variety of different kinds of “consumers” for these designs and analyses. A homebuilder needs a certain subset of project information while a firm that constructs an office park may need different elements.

What is needed is a tool that can create an “uber” project and data model from the project information and data from individual design programs, to enhance the sharing of information between them. Additionally the tool should be able to customize the delivery of project information to consumers.

### SUMMARY OF THE INVENTION

Different design programs use and produce different kinds of data. This data is typically of two types: (1) project data—which is basically a collection of metadata which includes file associations, project standards, workflow data and other information; and (2) the actual design elements (graphics, object properties). The metadata and design elements are both different, and stored differently by each design program, although many of the elements (e.g. placed files, sheets) are conceptually similar across products.

One or more embodiments of the invention solves the interoperation problem by noting that the concept of a “project” is more general and widely scoped than simply managing the working set of a particular design application. Rather the project represents and collates all the: design elements, operational parameters, dependencies, milestones, releases, revisions, communication records and status of all the various elements in the design into an “uber-project” definition. When a design application makes use of an embodiment of the invention for its project representation, the application inherits all of this “uber-project” definition as well. Furthermore, when several different design applications make use of the same project each application's aspect of the project may be managed as part of the whole project.

The end result of this is that each application (and user of that application) is provided with the ability to see the data (and related files) that is appropriate. Further, as that data is updated, the updates are consumed as part of a wider-affect update that may influence other applications (according to defined business rules) accessing the project. For example a change to a specific sheet in a CAD sheet-set may affect part of a civil engineering or building application model.

Accordingly, the invention allows these various design applications (and their users) to share and collaborate project data in an environment that is suitable to the application's/user's needs and provides tools to evade the pitfalls associated with application interoperation.

### BRIEF DESCRIPTION OF THE DRAWINGS

Referring now to the drawings in which like reference numbers represent corresponding parts throughout:

FIG. 1 schematically illustrates a hardware and software environment in accordance with one or more embodiments of the invention;

FIG. 2 illustrates the structure of a core project in accordance with or more embodiments of the invention;

FIG. 3 illustrates the interface between a server application of the invention and various design applications in accordance with one or more embodiments of the invention; and

FIG. 4 is a flow chart illustrating the logical flow for synchronizing data models across multiple applications in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

One or more embodiments of the invention overcome the problems of the prior art through a server based model. A universal representation of a project is defined and maintained on a server application (referred to herein as Blade). In addition, plug-ins or controls are added to the existing design applications on the client. Each plug-in provides a mechanism to convert application specific project data from the design application to the universal definition of the project on the server and vice versa. In addition, the server based application monitors any changes made to the project data by one application and notifies/updates the appropriate “dependent” applications according to well defined business rules. The model for the project data is therefore maintained on the server yet coordinates and synchronizes the project data across the multiple applications.

### Potential Advantages of One or More Embodiments

In view of the disadvantages of the prior art described above, one or more embodiments of the invention may provide various advantages. For example, the use of the server based application allows the establishment of a significant presence in behind-the-firewall data management while providing collaborative design and lifecycle management. In addition, by establishing a presence within a corporate network in terms of a product that holds and maintains the corporation's data, the server application is integrated in and becomes an instrumental part of the corporation's work environment.

A single data-management system of the invention that represents and manages the “project” data generated by numerous design vertical applications is also ideally suited to facilitating data exchange and workflows between various products and applications. Such capabilities provide cross-divisional project unification. In this regard, by providing an open project metaphor that all numerous applications can interface with opportunities are presented for using any number of different applications on a project in an effective way. Additionally data-management products become the center of a larger eco-system of design data rather than being focused at individual disciplines or market-segments.

In the design, build and construction market a large number of companies are typically involved in downstream workflows. Some online collaboration applications may address such workflows by providing a hosted service. Embodiments of the invention may integrate with such online collaboration applications by providing seamless exchange of data between a corporate-hosted project, in the architecture/engineering organization, and the online (downstream) project. Embodiments of the invention may also present opportunities for providing tailored project and workflow solutions client applications in an effective fashion.

In addition, embodiments of the invention provide a design project system that facilitates collaboration between design teams of different disciplines. Common industry workflows may also be integrated with project-management techniques in a non-disruptive fashion. Further, tailored workflow and project solutions are efficiently enabled to industry segments. In this regard, embodiments provide a common set of project-management models and workflows out of the box. Also, since many users in the design, building and construction market have specifically tailored processes, embodiments are extensible.

Embodiments of the invention may also be targeted to various particular users. For example, the invention may be utilized by a CAD Manager that is typically responsible for the initial project setup and ongoing maintenance and flow of information in and out of a design project. Because of the importance of correct revision control and document release, such responsibilities often falls to a single “gatekeeper” who accomplishes a lot of this work in a manual (but single point) fashion. The invention may provide a project-management model as well as automated workflows with dashboards to track various aspects of the project. Accordingly, a CAD Manager is provided with the tools to easily track and automate the various actions he is performing manually today. Additionally, the option to tailor the solution to their requirements will further allow embodiments to more accurately assist the CAD Manager.

An additional user that may gain a benefit from the invention is an architect. An architect is focused primarily on the design process and typically does not want to spend significant time on the workflow and tracking aspects of a project. That is the CAD Manager's role although this can also fall on the architect in a small company. Additionally, with distributed teams and out-sourcing becoming more common-place, architects are requiring more sophisticated workflows and communication systems for effective design collaboration between offices. Embodiments of the invention integrate workflow and communication directly into the design application so the architect can leverage the project communication and workflow without changing context or learning a new environment.

A general contractor (GC) may also benefit from the invention. The GC is usually receiving designs from an architect and is responsible for submitting “as-built” designs for construction. He is also acting as the “gatekeeper” for data flowing to and from a team of sub-contractors. As such he is both receiving drawings and performing round-trip workflows of derivative building designs and specifications. Embodiments of the invention may include a “Submittals” system that automates this as a downstream workflow from the initial design process. Having this capability centrally on a server-based system is effective because this involves communication between multitudes of companies. However, once the design data is downloaded from such a server based application there is no longer any tracking or automated workflow. Embodiments of the invention may operate as an “end-point” to this process by solving the “last-mile” problem of data-flow ensuring the correct drawings are submitted and automating review and feedback processes for all parties involved.

A structural engineer is responsible for structural analysis of an architectural model as well as reviewing designs for submission for construction. Part of such an analysis involves the design of a structural/analytical model that then becomes part of the same project data. Embodiments of the invention allow these various designs to be represented within the same project with the relationships between them understood and controlled through workflows. Additionally, the workflow capabilities and relationship between applications of the invention provide upstream workflows for reviewing submitted designs.

A cross-functional team (Architect, Landscaper, Civil-Engineer, etc.) may also benefit from the invention. A single project configured in accordance with embodiments of the invention can represent several aspects of a design project simultaneously. For example, because the architectural, civil and structural models are all represented in the same system, an embodiment may facilitate data-flow between these models allowing a cross-functional group to easily manage the project each from their own discipline's perspective. Such data flow translates to several design verticals working off the same project model without any need for manual synchronization.

Different products may also be used in accordance with one or more embodiments of the invention (referred to as vertical collaboration). For example, AutoCAD™ (a product offered by the assignee of the present invention) may provide a collaborative project environment for managing projects based on sheet sets or plain DWG™ files. Embodiments of the invention may interoperate with the AutoCAD™ environment and will both consume and produce aspects of a sheet set as defined by the AutoCAD™ SSM™.

An additional line of vertical products are that of the products in the MSD™ (Mechanical Services Division) offered by the assignee of the present invention. Further, the ISD™ (Infrastructure Solutions Division) of the assignee of the present invention may offer a line of products compatible with embodiments of the invention. For example, the invention may provide support for a Civil-3D™ representation of a project allowing multiple designers to work on a single project as a Civil-3D™ project as well as other representations. Embodiments of the invention may interoperate with the Civil-3D™ project environment and allow a Civil-3D™ project to be “attached” to a project of the invention.

The building systems division (BSD™) of the assignee of the present invention may also provide various products that can be used in accordance with one or more embodiments of the invention. For example, embodiments of the invention may provide support for a project navigator representation of a project allowing multiple designers to work on a single project as a project navigator project as well as other representations. Embodiments may interoperate with such a project environment and allow a project to be “attached” to a project of the invention. The project of the invention may then provide support for workflows from other applications (e.g., Revit™ offered by the assignee of the present invention) as well by providing a common workflow environment for downstream workflows from Revit™ where published data is exchanged. In such a case, the project model may be derived from the Revit™ model but it remains in the Revit™ model.

### Hardware and Software Environment

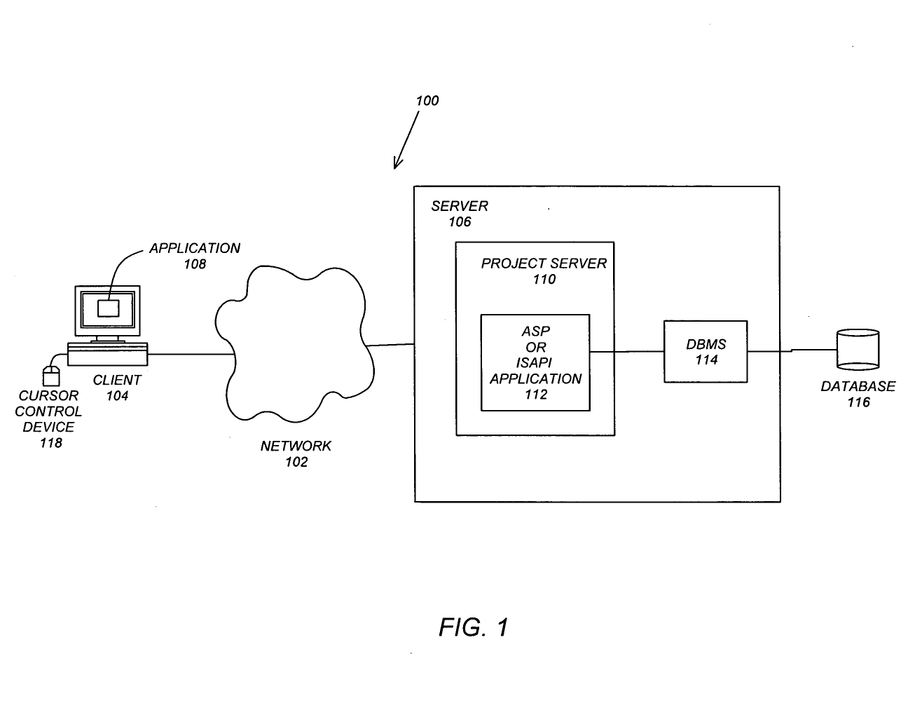

FIG. 1 schematically illustrates a hardware and software environment in accordance with one or more embodiments of the invention, and more particularly, illustrates a typical distributed computer system 100 using a network 102 to connect client computers 104 to server computers 106. A typical combination of resources may include a network 102 comprising the Internet, LANs, WANs, SNA networks, or the like, clients 104 that are personal computers or workstations, and servers 106 that are personal computers, workstations, minicomputers, or mainframes. Additionally, both client 104 and server 106 may receive input (e.g., cursor location input) and display a cursor in response to an input device such as cursor control device 118.

A network 102 such as the Internet connects clients 104 to server computers 106. Additionally, network 102 may utilize radio frequency (RF) to connect and provide the communication between clients 104 and servers 106. Clients 104 may execute a client application 108 or Web browser and communicate with server computers 106 executing project servers 110 or web servers. Such an application 108 may consist of any application that assists in the design, analysis, and construction of sites, facilities, and the mechanical devices they employ. Many such applications 108 are available from the assignee of the present invention such as AutoCAD™, ADT™, Civil 3D™, etc.

Further, the software executing on clients 104 may be downloaded from server computer 106 to client computers 104 and installed as a plug in or ActiveX control of the application 108. Accordingly, clients 104 may utilize ActiveX components/component object model (COM) or distributed COM (DCOM) components to provide a user interface on a display of client 104.

Project server 110 may host an Active Server Page (ASP) or Internet Server Application Programming Interface (ISAPI) application 112, which may be executing scripts. The scripts invoke objects that execute business logic (referred to as business objects). The business objects then manipulate data in database 116 through a database management system (DBMS) 114. Alternatively, database 116 may be part of or connected directly to client 104 instead of communicating/obtaining the information from database 116 across network 102. When a developer encapsulates the business functionality into objects, the system may be referred to as a component object model (COM) system. Accordingly, the scripts executing on project server 110 (and/or application 112) invoke COM objects that implement the business logic. Further, server 106 may utilize Microsoft's Transaction Server (MTS) to access required data stored in database 116 via an interface such as ADO (Active Data Objects), OLE DB (Object Linking and Embedding DataBase), or ODBC (Open DataBase Connectivity).

Generally, these components 108-118 all comprise logic and/or data that is embodied in or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Thus, embodiments of the invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass logic and/or data accessible from any computer-readable device, carrier, or media.

Those skilled in the art will recognize many modifications may be made to this exemplary environment without departing from the scope of the present invention. For example, those skilled in the art will recognize that any combination of the above components, or any number of different components, including different logic, data, different peripherals, and different devices, may be used to implement the present invention, so long as similar functions are performed thereby.

### Software Embodiment Details

As described above, different design programs use and produce different kinds of data. This data is typically of two (2) types—project data—which is basically a collection of metadata that includes file associations, project standards and other information; and the actual design elements (graphics, object properties). Although many of the elements (e.g. placed files, sheets) are conceptually similar across products, the metadata and design elements are both different, and stored differently by each program (e.g., AutoCAD™, ADT™, Civil 3D™, etc.).

In other words, design applications often have some kind of file or several files that represent the notion of a project. For example, a project can range from simply collecting a few design files together to being quite an extensive definition of a project. However, the files and method of managing projects is specific to each application and not interoperable.

One or more embodiments of the invention solves the interoperation problem by noting that the concept of a “project” is more general and widely scoped than simply managing the working set of a particular design application. Rather, the project represents (e.g., as an “uber-project”) and collates all of the: design elements, operational parameters, dependencies, milestones, releases, revisions, communication records and status of all the various elements in the design. When a design application makes use of an embodiment of the invention for its project representation, the application inherits all of this uber-project definition as well. Furthermore, when several different design applications make use of the same project, the project of the invention manages each application's aspect of the project as part of the whole.

In other words, embodiments of the invention introduce and define the notion of an uber project and “Project Data”. Project Data is all of the data that relates to the overall project and the integrity of the project itself (i.e., it ties together all of the pieces of the project).

The end result of this is that each application (and user of that application) gets to see the data (and related files) that is appropriate and as that data is updated the project consumes the updates as part of a wider-affect update that may influence other applications accessing the project. For example, a change to a specific sheet in an AutoCAD™ sheet-set may affect part of an AD™ or Civil-3D™ model.

Additionally, it may be noted that the invention is not attempting to unify the design-data in any way. Such design data remains in the domain of the design applications themselves. Embodiments of the invention simply allow these applications (and their users) to share and collaborate on this data in an environment that is suitable to their needs and that gives them the tools to evade the pitfalls associated with application interoperation.

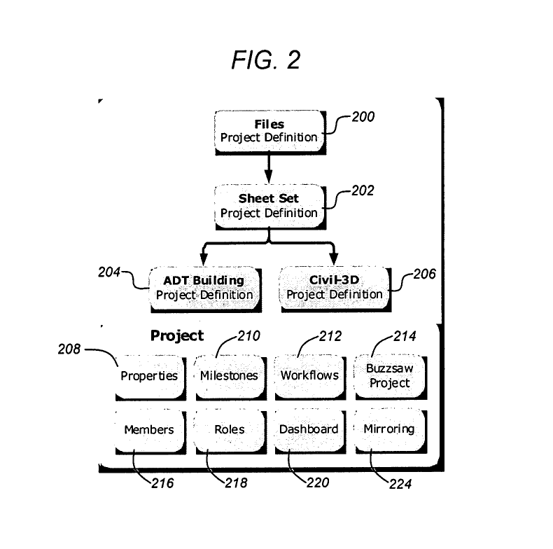

FIG. 2 illustrates the structure of a core project in accordance with or more embodiments of the invention. An application of the invention can support various “project definitions”. Each of the definitions may model a particular way of organizing project data. Accordingly, each project definition interprets (or extends) a project in a different way. Examples of possible project definitions include: a files and folders representation of what is in the project; a sheet-set representation, a building model representation, etc.

Some examples of typical project definitions are set forth in FIG. 2. Files 200 set forth the most basic definition of a project as a collection of files and folders with xrefs (external references) between files. An xref is a drawing file linked (or attached) to another drawing. Such files consist of a set of five basic objets that constitute the general project definition. The five objects may include (1) a project object—the basic notion of a project; (2) design objects—the notion that some of the items in the project object are design objects; (3) distributables—objects that are sent to another entity; (4) files—that constitute the project; and (5) references between those files.

Each application or different type of project may extend the project definition 200 in a different way. For example, when dealing with sheet sets, a sheet set is simply a collection of sheets, and for each sheet that corresponds to a file, that sheet may also be a design object. Accordingly, as illustrated in FIG. 2, the sheet set 202 extends the model of the files project definition 200. In this regard, sheet set 202 is created by generating definitions of sheet objects that are logical extensions of the file and the design objects from files project definition 200. The sheet set 202 is a collection of sheets organized into a hierarchy that maps directly to a Sheet Set Manager definition set forth in a CAD environment (e.g., AutoCAD™). The sheet set 202 understands the relationships to the basic files project definition 200 allowing either metaphor to be used interchangeably.

Such project definitions and extensibility is run-time extensible and can be easily added. For example, if a new application has ten (10) different design objects, such new design objects can be introduced into the model on the server and work seamlessly in accordance with embodiments of the invention.

As products/applications are added, the models may be extended in different directions. Accordingly initially, the uber-project definition (e.g., project definition 200) is created on the server as a type of place-holder for a project (e.g., a project with a name but lacking actual project data). As applications begin creating data linked to the project, the data is “attached” and introduced to the placeholder. In other words, the project objects are populated with design data.

The sheet set project definition 202 can further be extended into design data for specific applications. For example, a specific set of homes or buildings may be designed using various applications with each application having a specific format and mechanism for managing their design data. Accordingly, the sheet set data 202 can be extended into a building project definition 204 (e.g., an AD™ building project definition) or a civil engineering project definition 206 (e.g., a Civil-3D project definition). The building project definition 204 provides an organization of drawings to form the structure used and presented by a building project application manager (e.g., an Architectural Desktop Project Navigator available in ADT™ from the assignee of the present invention). The building project definition 204 understands the relationships to the sheet set definition 202, as well as the files definition 200, and thereby allows any of the three metaphors to be used interchangeably. Ultimately, the building project definition 204 will contain various “linked” definitions of a building project such as both the architectural and structural models of a building. Workflows and data-exchange may occur between these models.

The civil engineering project definition 206 is an organization of drawings that form the structure used and presented by a civil engineering project system (e.g., the Civil-3D™ project system available from the assignee of the present invention). The civil engineering project definition 206 understands the relationships to the sheet set definition 202 as well as the files definition 200 thereby allowing any of the three metaphors to be used interchangeably.

In view of the above, the core files project definition 200 consists of the five various objects that can be extended into a variety of different project definitions. In addition, the five objects may not be mutually exclusive. For example, a design object may also be a distributable. In this regard, a file that can be distributed and used in a design application (e.g., a DWG™ file) may be both a design object and a distributable. A sheet within a sheet set may also be both a design object and a distributable. Alternatively, an object that is a distributable but not a design object is a PDF file. A PDF file is a published version of a sheet that is going to be sent to someone. Accordingly, such a PDF file is not a design object since it cannot be directly used in a design application to manipulate a design. Thus, a design object is an element within a particular project definition 200 that can be loaded into a design application for the purposes of viewing or editing. Similarly, a distributable is a design object or an object that is derived from a design object (e.g., a published file) that can be distributed to other individuals in a workflow.

The file reference objects can be viewed as a mapping table for the relationship between two files that is stored separately and logically from both of the files/objects. For example, rather than storing the relationship between two files within the files themselves, the file references may be stored separately from the related files. Accordingly, if an action affects file A, rather than searching through all of the other files to determine if another file may be affected by the action to file A (i.e., another file has a dependent relationship on the file A), the application need only search the file references.

With any of the various project definitions 200-206, an application designed in accordance with embodiments of the invention is configured to offer various services. Such services are illustrated in the lower portion of FIG. 2. The properties services 208 are fundamental and extended sets of properties that contain overall project details (e.g., contract number, completion date, etc.) for each of the objects in a project definition 200-206. The properties 208 may be viewed as general project properties. Such properties may contain a set of standard fields that define it that include name, start-date, expected completion date, contract number, project number, status, etc. Since many applications define their own projects, there are parts of construction or design that are usually similar. For example, it is common to have a project name or project number as well as a manager's name associated therewith. The different applications have their own project formats and fields and properties for storing the common information. Embodiments of the invention permit the management of a centralized set of these properties. When an application begins to populate the project definition 200 with data, embodiments of the invention merge the properties 208 from the individual application into the generalized set of properties. The mechanism by which these properties are merged and managed are described in more detail below.

The milestone service 210 provides a set of milestones (defining phases of the project) by which all project data and workflows can be tracked. In other words, a milestone is a key point in a project related to contract agreements, deliverables, and required distribution of drawings (e.g., 25% set, bid-set, CDs, etc.). Thus, milestones are similar to a record keeping and tracking mechanism. Normally, on a construction project, there are defined milestones. On an average construction project, there are on the order of four or five milestones against which deliverables are tracked. Such milestones are key dates to meet on projects. An example milestone is reaching the 30% completion stage of a project. Such milestones are defined at the beginning of a project and may be part of a contract. Accordingly, it may be important to remain cognizant of such milestones during the design process. Embodiments of the invention allow the entry of such milestones and as data and files in a model change, the changes may be recorded to a specific milestone dependent on when such changes occur. Embodiments may track milestone completion (or partial completions) and permit the reporting of changes based on milestones or allow the ability to track data changes by different milestones. Further, milestones often include names, dates, and status.

The workflows service 212 controls how data flows in and out of the project (e.g., a review-approve process). Such workflows 212 are transmittal-based workflows. In the traditional architectural world, a set of blueprints is merely printed and sent to another party with a letter. The intent of such a transmission is either to simply deliver designs to the party or to establish a round-trip workflow wherein comments or some additional action is required by one of the parties. Workflows 212 allow a person working in a design application to transmit a set of distributables (e.g., from files project definition 200) along with a transmittal form that establishes the desired/expected action of the receiving party (e.g., a reply with comments is expected in two weeks). The workflow service 212 provides the ability to create the transmittal form and transmit both the transmittal form and the desired distributable to the receiving party electronically. Further, transmittals may be used in three different general categories: (1) for transmitting a design to a receiving party; (2) a round-trip transmittal (e.g., a reviewing type of workflow); and (3) a publishing or print order workflow wherein a set of design data or files are transmitted to a reprographer for printing.

The Buzzsaw™ project service 214 may be used in connection with the Buzzsaw™ application available from the assignee of the present invention. Buzzsaw™ is a collaborative project management application that provides simple, secure access to project assets and information on-demand. Thus, a project definition 200-206 can be setup to relate directly to a project on Buzzsaw™. In this regard, a project of the invention can communicate transparently with Buzzsaw™ while allowing the Buzzsaw™ project to contain and control all downstream workflow data. Thus, the Buzzsaw™ project service 214 provides the ability to transmit any object within a project definition 200-206 view the Buzzsaw™ application. For example, the workflow project service 212 may deliver the transmittals via the Buzzsaw™ service/server. Accordingly, the Buzzsaw™ project service 214 may be viewed as a local network extension of Buzzsaw™. The service 214 connects to a Buzzsaw™ server, pushes data downstream to a Buzzsaw™ server and can pull the data back up as well. An application of the present invention can be implemented on a server that exists behind a firewall and allows the storage and management of data locally. In addition, when the appropriate time arises, the Buzzsaw™ project service 214 can connect to a Buzzsaw™ server and transmit the relevant data to a wider group of people.

The members project service 216 provides a list of users that are members of the project. In other words, the members service 216 may be viewed as a mechanism for tracking the people that are actually working on a project.

The roles project service 218 provides the ability to assign the members (i.e., the list of users) predefined roles that control what the member can do within a project. In other words, the roles establish and control the permissions and the ability to access properties or objects within a project.

The dashboard project service 220 provides a console that allows each user to effectively monitor the status of the design data and the pending workflows related to the user. Such monitoring may include the notion of an inbox of all pending issues as well as overview consoles for roles such as the project administrator. In other words, a dashboard is a console provided to a project participant that allows the participant to have a quick overview of the contents and status of a project. Such a console can be considered a “live” and interactive report that may be updated dynamically.

There may be two different types of dashboards: (1) a simple dashboard used for the actual user of a design application that informs the user of the status of the data (e.g., certain files are being utilized and/or the user is waiting for a particular workflow to arrive back from a recipient, etc.); and (2) a server based dashboard that is utilized by a project administrator or manager that provides information and reports against the data stored in a project server of the invention (e.g., an examination of the history of milestones and changes over time, etc.). The server based dashboard may be viewed as a real-time reporting mechanism.

The mirroring project service 224 is a specialized workflow for synchronizing the contents of a project through a Buzzsaw™ project to allow multiple remote servers to represent the same project. In other words, as described above, a project server of the invention may lie behind a firewall and be used to exchange information locally. However, additional local networks may also be working on the same project but may be maintaining their own data on their local server. The mirroring service 224 provides the ability to mirror and synchronize the data on the two servers via Buzzsaw™. In this regard, data can be pushed to and from the various servers using the Buzzsaw™ application.

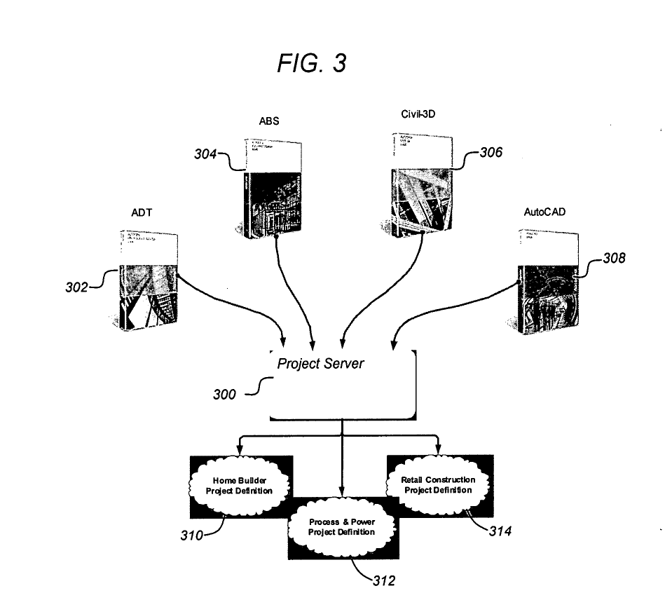

As described above, a design application may utilize and manage a project and an “uber-project” definition in accordance with one or more embodiments of the invention. The “uber-project” that embodiments of the invention manage is ultimately not driven by the individual design applications (although they may drive the details of what the project maintains) but is rather driven by the nature of the project and its market segment. FIG. 3 illustrates the interface between a server application 300 of the invention and various design applications 302-308. As FIG. 3 depicts, a home builder 310 using several design 302-308 applications may interface with a project (of an embodiment of the invention) whose structure is defined in the way that home-builders organize and track their data. This is specifically important when considering the communication and workflow related data maintained as part of the project. Ultimately, parts (or the whole) of this project definition 310 can be carried through the entire lifecycle of the project (e.g., within Buzzsaw™ and between project servers 300). Feasibly, this model may also be carried within design files or distributables as part of downstream transport.

Additionally, as described above, the project server 300 of the invention relates users to roles and these roles can be assigned access to specific aspects of this project hence limiting what each application can do to the overall project for these uses. The project server 300 achieves this through an extensible database architecture (for project representation) and a method of encoding the business rules for maintaining the integrity of the overall project. The database uses an object-oriented approach that represents the relationships between the various project elements and that is easily extensible by a design application, a consultant and ultimately the customer himself.

As illustrated in FIG. 3, various applications offered by the assignee of the present invention (e.g., AD™ 302, ABS™ 304, Civil-3D™ 306, and AutoCAD™ 308) interface with the project server 300 and utilize various project definitions 310-314 that are specific for a particular type of project. In this regard, the project definitions of FIG. 2 are extended beyond the basic design application into the specific project definitions illustrated such as a home builder project definition 310, a process and power project definition 312, and a retail construction project definition 314. For example, most design companies may have a specific manner in which they design and manage the data for a set of homes. The company has their own proprietary data that they track against. Such data may relate strongly back to the design data but is not likely to be used by a particular design application 302-308. The project server 300 allows the mechanisms described above to extend the project definition 200 beyond what the other design applications 302-308 are going to use. Instead, a new project definition may be create and used by the home builder. The project server 300 would then commute the data from the other applications 302-308 into the format and properties of the home building model 310. In other words, the project server establishes the relationship between the underlying design data and the data for the particular application end use 310-314 as desired.

### Client-Server Interaction

Referring again to FIG. 1, the design applications 108 on clients 104 interact with, and exchange information with other clients 104 through project server 110. As described above, the project server 110 maintains the uber-project definitions 200 that is utilized and shared by the various design applications 108. Accordingly, the project information and data from design applications 108 and that existing in project server 110 should be synchronized. Multiple issues arise with respect to such synchronization. The first issue is that of backward compatibility. Backward compatibility refers to the ability for existing/legacy design applications to synchronize with the uber project data stored on a new project server 110. Such design application 108 capability is not an issue with respect to future releases of design applications since such applications may be built with the knowledge that such synchronization needs to occur and can therefore be designed accordingly. The second issue that arises is that of collaboration among a large group of people/entities across multiple different applications.

To overcome both issues described above, one or more embodiments of the invention provide a behind the firewall server 110 that manages the uber-project data. The project server 110 manages all of the people on the project and provides a central location for all users to access design data for a project.

To provide the ability to synchronize the data, a plug-in or other type of control is installed or attached to the design application 108. Similarly, the project server 110 has a plug-in type of model. The client side plug-in provides a mechanism to convert between the unified definition of the project (i.e., the uber-project definition) (which the project server 110 manages) and the specific definition needed by the design application 108 (and vice versa). Accordingly, the plug-in on the client 104 has the ability to convert to and from the specific design application project data and the server-based uber-project/unified definition. For example, the client-based plug-in may convert the abstract representation from the project server 110 and generate a sheet set project file that a CAD program may utilize. Similarly, when data is being imported from the design application 108 to the project server 110, the client-side plug-in will convert the sheet set file and generate the abstract project definition that is stored and utilized by the project server 110.

Continuing with the CAD design application example, as described above, a sheet set may be converted to the unified project model on the project server 110. A civil engineer working in another design application (e.g., Civil-3D™) may have a different project definition (different and distinct in structure) but still part of the same project. The engineering-based design application may execute a different plug-in that converts its data to the unified/uber-project definition. The two different project definitions (e.g., from the CAD design application and the engineering design application) are then merged on the server (i.e., through the five basic objects of the project definition 200).

Further, as described above, when the client-side plug-in provides the data to the project server 110, the plug-in is essentially populating any project placeholder objects with design data that have not yet been populated (or updates those that have not yet been populated).

The above process provides the ability for the data to be used by different design applications 108 and to populate the unified project definition on the server 110. However, edits performed in one design application 108 may affect settings or properties of the project definition in another design application 108. For example, if a user modifies or deletes a design object or file in a civil project design application, such an edit may affect or impact a structural project that another user is editing in a CAD design application. In this regard, a predefined logical correlation may exist between various design applications (e.g., between a set of sheets and a civil engineering project). To accurately synchronize the data on the client 104 and server 106, a representation of the logical correlation should be stored somewhere. In accordance with one or more embodiments of the invention, the plug-in model on the server represents and stores such a logical correlation. The representation may be viewed as a set of events or set of reactor objects. Such reactor objects provide for an action, a relationship, and a resulting reaction. Thus, the reactor object provides that when a particular object changes in one model, then another model would react in a particular manner.

As an example of the use of the reactor objects within project server 110, assume a user is defining the civil engineering plug-in for the server. The plug-in may identify a sheet model and a fundamental files model as having a logical relationship to the civil engineering model. Accordingly, the project server 110 will monitor the sheet model and fundamental files model. Logic within the plug-in will provide that if a user deletes a sheet in the sheet model, then the civil model will be modified in a particular manner (e.g., by deleting any references to the deleted sheet). Accordingly, the different server plug-ins for the different models each maintain knowledge regarding how to modify their own model based on modifications to another model. Thus, as events occur, such events are monitored by the server side plug-ins and used to modify other logically correlated/dependent models thereby synchronizing the data across all of the models.

In addition to the synchronization via the server-side plug-ins, embodiments of the invention maintain the integrity. In this regard, the objects (e.g., design objects and/or files) may be lockable objects that may propagate up the hierarchy of FIG. 2. For example, if a sheet in the ADT Building project definition 204 is being edited, a sheet object may be locked at the files project definition 200 level such that if the Civil 3D project definition 206 attempts to use or modify the object, such permission may not be granted. The locking mechanism of embodiments of the invention are similar to a check-in/check-out metaphor wherein a user checks out a file or object which propagates down to the basic fundamental project definition 200 and thereby obtains a lock on that file or object. Once the user's action is complete, the file or object is checked back in thereby releasing the lock and triggering the server-side plug-in to update any affected/dependent models.

### Logical Flow

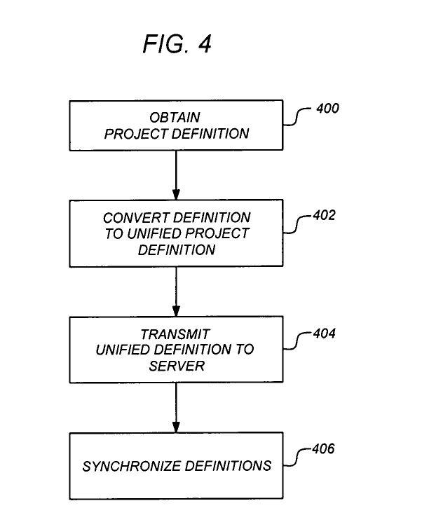

FIG. 4 is a flow chart illustrating the logical flow for synchronizing data models across multiple applications in accordance with one or more embodiments of the invention. At step 400, one or more files that comprise a first application project definition that are specific to a first computer design application are obtained (i.e., on a first client computer). Such a first application project definition is specific and unique to a particular design application.

At step 402, the first application project definition is converted into a unified project definition that is utilized by a server application. As described above, the conversion takes place on the client computer (or alternatively can occur on the server computer) and likely takes place within a conversion application. Such a conversion application may comprise a plug-in for the particular client based design application. Thus, multiple plug-ins exist for each of the different design applications that are each configured to convert the application specific definition into the unified definition for the server.

As set forth above, the unified definition may comprise a project object (providing the general notion/existence of an object), a design object (objects in the project that can be designed by the particular design application), a distributable object (an object that can be forwarded/transmitted to another party), one or more file objects (that identifies the files that constitute the project), and a reference object(s) (comprising a relationship between the one or more file objects). This project definition is also extendable.

At step 404, the unified project definition is sent/transmitted from the client to a server application. The server application is configured to store the unified project definition and synchronize the various design application specific project definitions with the unified definition at step 406. Such a server application may also be a plug-in type of application or may be a project server that resides in a server.

The synchronization may be provided by monitoring the unified definition for any modifications (i.e., of the unified project definition) received from a client computer (e.g., from a conversion application). Thereafter, the server determines if a received modification affects other application specific project definitions. If other application-specific project definitions are affected, the unified definition is sent to the converting application of the specific design application responsible for the affected application specific project definition. The converting application converts the unified definition to the application specific project definition and updates the information on the client appropriately.

Such synchronization by the server may be performed via reactor objects. Such reactor objects set forth a condition, relationship, and reaction. The condition specifies a modification to a particular property of the unified project definition. The relationship is between the modified property and a second property of another application specific project definition. The reaction specifies an action to be performed with respect to the affected second property (i.e., that is specified in the relationship) when the condition has been fulfilled. Consequently, the reactor objects provide the ability to monitor and cause an update to be transmitted when a modification to the unified definition affects a property/attribute of an application-specific project definition.

The server may also be configured to provide various services as described above. Such services may include a properties service that provides an extended set of properties that comprise project details for one or more objects in the unified project definition. Another project service is a milestone service that comprises a set of milestones that define phases of a project that can be tracked. A transmittal-based workflow service may be used to control how data flows in and out of a project. Further, a members project service may provide a list of users that are members of a project with a roles project service that assigns the members of the project predefined roles that control what each member can do within the project. In addition, a dashboard project service provides a console that allows a user to monitor the status of a project.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for synchronizing data models across multiple computer applications, comprising:
(a) obtaining, on a first client computer, in a first computer design application, one or more files that comprise a first application project definition specific to the first computer design application;
(b) converting, on the first client computer, using a first application specific conversion application, the first application project definition, into a unified project definition that is utilized by a server application; and
(c) transmitting the unified project definition to the server application, wherein the server application is configured to:
(i) store the unified project definition; and
(ii) synchronize the unified project definition with one or more second computer design applications.

2. The method of claim 1, wherein the server application is configured to synchronize the unified project definition with one or more second computer design applications by:
monitoring the unified project definition for any modifications to the unified project definition received from the first client computer;
determining if a received modification affects one or more second application project definitions specific to the one or more second computer design applications; and
if the received modification affects one or more second application project definitions specific to the one or more second computer design applications, transmitting the modified unified project definition to one or more second application specific converting applications, wherein each second application specific converting application is configured to convert the unified project definition to the affected second application project definition specific to the second computer design application.

3. The method of claim 1, wherein the first application specific conversion application comprises a plug-in application for the first computer design application.

4. The method of claim 1, wherein the server application is further configured to maintain one or more reactor objects that comprise:
a condition comprising a modification to a first property of the unified project definition;
a relationship between the first property and a second property of a second application project definition; and
a reaction comprising an action to be performed to the second property when the condition has been fulfilled.

5. The method of claim 1, wherein the unified project definition comprises:
a project object;
a design object;
a distributable object;
one or more file objects; and
a reference object comprising a relationship between the one or more file objects.

6. The method of claim 5, wherein the unified project definition is extendable.

7. The method of claim 5, wherein the server application is further configured to provide a properties service that provides an extended set of properties that comprise project details for one or more objects in the unified project definition.

8. The method of claim 1, wherein the server application is further configured to provide a milestone service that comprises a set of milestones that define phases of a project.

9. The method of claim 1, wherein the server application is further configured to provide a workflow service that controls how data flows in and out of a project.

10. The method of claim 1, wherein the server application is further configured to provide a members project service that provides a list of users that are members of a project.

11. The method of claim 10, wherein the server application is further configured to provide a roles project service that assigns the members of the project predefined roles that control what each member can do within the project.

12. The method of claim 1, wherein the server application is further configured to provide a dashboard project service that provides a console that allows a user to monitor a status of a project.

13. An apparatus for synchronizing data models across multiple computer applications comprising:
(a) a server computer having a memory;
(b) a server application executing on the server computer, wherein the server application is configured to:
(i) receive from a first client computer, a unified project definition that has been converted, using a first application specific conversion application, from one or more files that comprises a first application project definition specific to a first computer design application executing on the first client computer;
(ii) store the unified project definition; and
(iii) synchronize the unified project definition with one or more second computer design applications.

14. The apparatus of claim 13, wherein the server application is configured to synchronize the unified project definition with one or more second computer design applications by:
monitoring the unified project definition for any modifications to the unified project definition received from the first client computer;
determining if a received modification affects one or more second application project definitions specific to the one or more second computer design applications; and
if the received modification affects one or more second application project definitions specific to the one or more second computer design applications, transmitting the modified unified project definition to one or more second application specific converting applications, wherein each second application specific converting application is configured to convert the unified project definition to the affected second application project definition specific to the second computer design application.

15. The apparatus of claim 13, wherein the first application specific conversion application comprises a plug-in application for the first computer design application.

16. The apparatus of claim 13, wherein the server application is further configured to maintain one or more reactor objects that comprise:
a condition comprising a modification to a first property of the unified project definition;
a relationship between the first property and a second property of a second application project definition; and
a reaction comprising an action to be performed to the second property when the condition has been fulfilled.

17. The apparatus of claim 13, wherein the unified project definition comprises:
a project object;
a design object;
a distributable object;
one or more file objects; and
a reference object comprising a relationship between the one or more file objects.

18. The apparatus of claim 17, wherein the unified project definition is extendable.

19. The apparatus of claim 17, wherein the server application is further configured to provide a properties service that provides an extended set of properties that comprise project details for one or more objects in the unified project definition.

20. The apparatus of claim 13, wherein the server application is further configured to provide a milestone service that comprises a set of milestones that define phases of a project.

21. The apparatus of claim 13, wherein the server application is further configured to provide a workflow service that controls how data flows in and out of a project.

22. The apparatus of claim 13, wherein the server application is further configured to provide a members project service that provides a list of users that are members of a project.

23. The apparatus of claim 22, wherein the server application is further configured to provide a roles project service that assigns the members of the project predefined roles that control what each member can do within the project.

24. The apparatus of claim 13, wherein the server application is further configured to provide a dashboard project service that provides a console that allows a user to monitor a status of a project.

25. An article of manufacture comprising a program storage medium readable by a first client computer and embodying one or more instructions executable by the first client computer to perform a method for synchronizing data models across multiple computer applications, the method comprising:
(a) obtaining, on the first client computer, in a first computer design application, one or more files that comprise a first application project definition specific to the first computer design application;
(b) converting, on the first client computer, using a first application specific conversion application, the first application project definition, into a unified project definition that is utilized by a server application; and
(c) transmitting the unified project definition to the server application, wherein the server application is configured to:
(i) store the unified project definition; and
(ii) synchronize the unified project definition with one or more second computer design applications.

26. The article of manufacture of claim 25, wherein the server application is configured to synchronize the unified project definition with one or more second computer design applications by:
monitoring the unified project definition for any modifications to the unified project definition received from the first client computer;
determining if a received modification affects one or more second application project definitions specific to the one or more second computer design applications; and
if the received modification affects one or more second application project definitions specific to the one or more second computer design applications, transmitting the modified unified project definition to one or more second application specific converting applications, wherein each second application specific converting application is configured to convert the unified project definition to the affected second application project definition specific to the second computer design application.

27. The article of manufacture of claim 25, wherein the first application specific conversion application comprises a plug-in application for the first computer design application.

28. The article of manufacture of claim 25, wherein the server application is further configured to maintain one or more reactor objects that comprise:
a condition comprising a modification to a first property of the unified project definition;
a relationship between the first property and a second property of a second application project definition; and
a reaction comprising an action to be performed to the second property when the condition has been fulfilled.

29. The article of manufacture of claim 25, wherein the unified project definition comprises:
a project object;
a design object;
a distributable object;
one or more file objects; and
a reference object comprising a relationship between the one or more file objects.

30. The article of manufacture of claim 29, wherein the unified project definition is extendable.

31. The article of manufacture of claim 29, wherein the server application is further configured to provide a properties service that provides an extended set of properties that comprise project details for one or more objects in the unified project definition.

32. The article of manufacture of claim 25, wherein the server application is further configured to provide a milestone service that comprises a set of milestones that define phases of a project.

33. The article of manufacture of claim 25, wherein the server application is further configured to provide a workflow service that controls how data flows in and out of a project.

34. The article of manufacture of claim 25, wherein the server application is further configured to provide a members project service that provides a list of users that are members of a project.

35. The article of manufacture of claim 34, wherein the server application is further configured to provide a roles project service that assigns the members of the project predefined roles that control what each member can do within the project.

36. The article of manufacture of claim 25, wherein the server application is further configured to provide a dashboard project service that provides a console that allows a user to monitor a status of a project.
